(19) United States
(12) Patent Application Publication
(10) Pub. No.: US 2007/0118499 A1
(43) Pub. Date: May 24, 2007

(54) Method and system for collecting and restoring application state information

(75) Inventors: Tae In Hwang, Daejeon (KR); Ho Jin Park, Daejeon (KR)

Correspondence Address: LADAS & PARRY LLP, 224 SOUTH MICHIGAN AVENUE, SUITE 1600, CHICAGO, IL, 60604, US

(73) Assignee: Electronics & Telecommunications Research Institute

(21) Appl. No.: 11/602,027

(22) Filed: Nov. 20, 2006

(30) Foreign Application Priority Data
Nov. 24, 2005 (KR) 10-2005-0113082

(51) Int. Cl. G06F 17/30

(52) U.S. Cl. 707/1

(57) ABSTRACT

A method and system for collecting and restoring application state is provided. To process application state information, the system registers various types of applications, searches for an application control library of an application which a user has selected from registered applications, dynamically links to the found application control library, and selectively collects and restores state information of the application using the dynamically linked application control library. Thus, the system can dynamically add or modify an application control interface for selectively collecting and restoring the application state information, thereby improving the security of personal data.

### BACKGROUND OF THE INVENTION

1. Field of the Invention

The present invention relates to a method and apparatus for collecting and restoring application state information, and more particularly to a method and apparatus for collecting and restoring application state information based on custom application control libraries.

2. Description of the Related Art

A conventional application migration service collectively collects and stores state and session information of applications, which are running on a terminal, in a server when a user of the terminal moves to another place and restores and provides the same operating environment as the previous one to another terminal in the place to which the user moves.

However, in some cases, the user may not desire to back up and restore all the application states. For example, let us assume that, while working to produce a presentation document using Microsoft Power Point running on the terminal with family photos opened with an image viewer program running on the terminal, the user backs up application state information in order to work together with a team member to prepare the presentation document and then restores the application state information on a computer of the team member. If all the application states have been collectively backed up, the team member not only can open the presentation document with which the user was working using Power Point but also can open the family photos of the user using an image viewer program. This may invade the privacy of the user without the user even knowing it. To overcome this problem, it is necessary to provide a method for selectively backing up and restoring only application state information desired by the user.

It is difficult for the conventional application registration method to simultaneously handle a variety of applications since the application registration method has not yet been standardized and also depends on an interface provided by each application.

Microsoft Office provides a method for collecting and restoring application states using a Component Object Model (QOM) object that defines a standard interface for communication and data exchange between components. However, it is difficult for this method to handle a variety of applications since the method highly depends on each application.

Further, conventionally, program developers perform hard-coding of an application state information management client program of an application to be suitable for a known interface for controlling the application. Accordingly, when a new application is added, it is difficult to automatically register the application and to dynamically add and modify an application control interface provided to selectively collect or restore application state information of the application.

### SUMMARY OF THE INVENTION

Therefore, the present invention has been made in view of the above problems, and it is an object of the present invention to provide a method and apparatus for collecting and restoring application state information, which can automatically register and link to an application control library at the request of a user, thereby selectively collecting or restoring application state information.

In accordance with one aspect of the present invention, the above and other objects can be accomplished by the provision of a method for collecting and restoring application state, the method comprising receiving information of an application and registering the application; searching for an application control library of an application which a user has selected from registered applications; dynamically linking to a found application control library; and selectively collecting and restoring state information of the application using the dynamically linked application control library.

In accordance with another aspect of the present invention, there is provided a system for collecting and restoring application state, the system comprising an application state management processor that receives information of an application and registers the application and that selectively collects and restores state information of the application using an application control library used to control the registered application; and an application control library server that manages a plurality of application control libraries and provides the application control library for controlling the registered application to the application state management processor.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a system for collecting and restoring application state information according to an embodiment of the present invention;

FIG. 2 is a block diagram of a system for collecting and restoring application state information according to another embodiment of the present invention;

FIG. 3 is a block diagram of a system for collecting and restoring application state information according to yet another embodiment of the present invention; and

FIG. 4 is a flow chart of a method for collecting and restoring application state information according to an embodiment of the present invention.

### DESCRIPTION OF THE PREFERRED EMBODIMENTS

Preferred embodiments of the present invention will now be described in detail with reference to the accompanying drawings. In the drawings, the same or similar elements are denoted by the same reference numerals even though they are depicted in different drawings. In the following description of the present invention, a detailed description of known functions and configurations incorporated herein will be omitted when it may obscure the subject matter of the present invention.

In the following description, a method and system for selectively collecting or restoring application state information according to the embodiments of the present invention will be described in detail with reference to the accompanying drawings.

The term “application state information” used in the embodiments of the present invention refers to information of a document file with which the user is working, position information of the page of a document with which the user is working, toolbar position information, application window size and position information, information of a music and moving image file which is being played and playback position information of the music and moving image file, favorite site information, and the like. This variety of application state information is set forth herein only for illustrative purposes and the present invention is not limited thereto. It should be noted that the term “application state information” used in the present invention includes any information which can express a state of the application.

The term “application” refers to an application such as Microsoft Office, Linux Open Office, Winamp, Window Media Player, or Internet Explorer. These applications are set forth herein only for illustrative purposes and the present invention is not limited thereto. It should be noted that the term “application” includes any program that runs on a device including a processor and a memory.

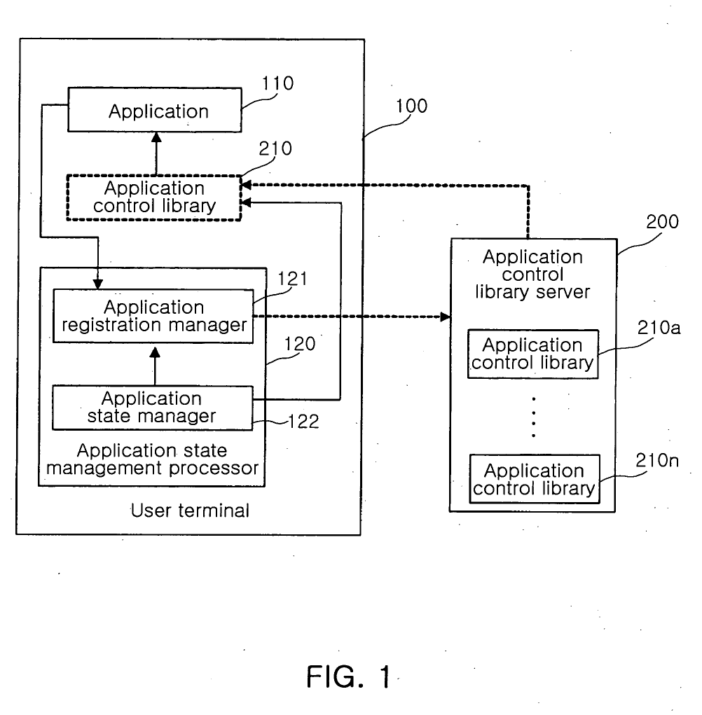

FIG. 1 is a block diagram of a system for collecting and restoring application state information according to an embodiment of the present invention.

As shown in FIG. 1, the application state information collection and restoration system includes a user terminal 100 and an application control library server 200.

The user terminal 100 includes applications 110 and an application state management processor 120 including an application registration manager 121 and an application state manager 122. The application control library server 200 includes one or more application control libraries 210a, . . . , 210n.

The application registration manager 121 in the application state management processor 120 receives application information directly from the applications 110 and registers the received application information and assigns a unique ID to each application. The registration manager 121 may generate an identifier (ID) of each application to identify the application or alternatively may request it from the application control library server 200 and assigns an identifier received from the library server 200 to the application.

The application registration manager 121 searches for an application control library of a backup target application, which a user has selected from the registered applications, and dynamically links to a found application control library 210.

The application state manager 122 in the application state management processor 120 collects or restores application state information of the backup target application using the dynamically linked application control library and manages the collected and restored state information.

Other structures of the application state information collection and restoration system according to other embodiments of the present invention will now be described with reference to the drawings.

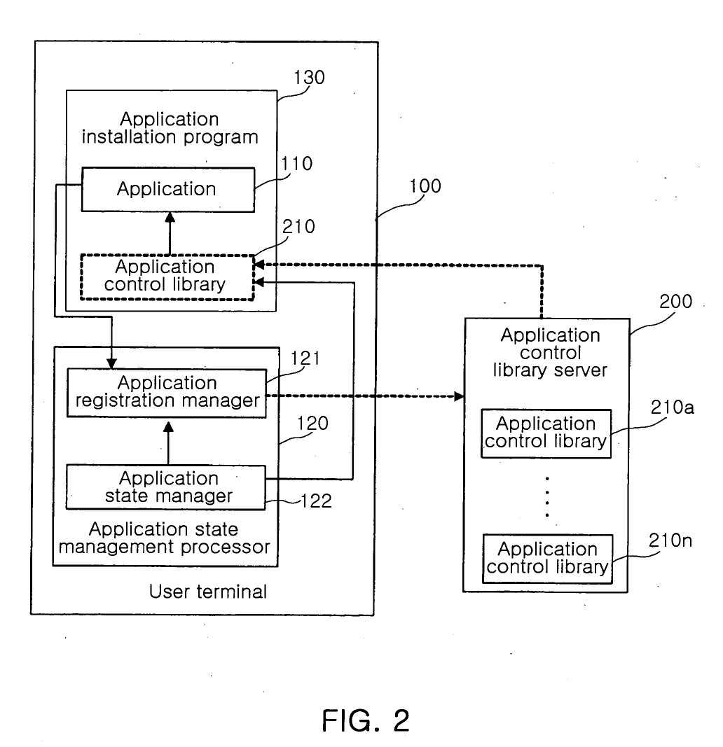

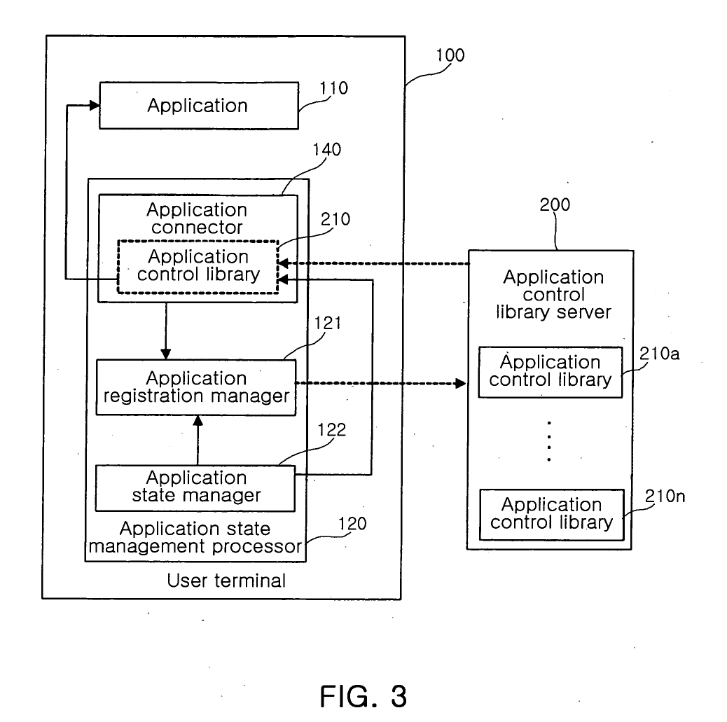

FIG. 2 is a block diagram of a system for collecting and restoring application state information according to another embodiment of the present invention and FIG. 3 is a block diagram of a system for collecting and restoring application state information according to yet another embodiment of the present invention.

The application state information collection and restoration system as shown in FIG. 2 or FIG. 3 has the same elements as those of the system of FIG. 1. However, the application registration manager 121 of FIG. 2 or FIG. 3 receives application information from an application installation program 130 (see FIG. 2) or an application connector 140 (see FIG. 3). The application connector 140 provides a registration request function on behalf of an application which supports no automatic registration function and provides no application control library. When application information is provided from the terminal, i.e., from the application 110, the application installation program 130, or the application connector 140, the application control library 210 may be provided while being included in the application information and then be stored to be provided at a later time. Alternatively, the application control library 210 may be downloaded from the application control library server 200.

The application registration manager 121 provides a function to collect and restore application state information of an application when the application (110), the application installation program 130, and the application connecter 140 has made a request to cancel the registration of the application. In addition, the application registration manager 121 cancels registration of the application upon completion of the collection and restoration of the state information of the application.

A method for collecting and restoring application state information based on an application control library in the application state information collection and restoration system according to the embodiment of the present invention will now be described with reference to the accompanying drawings.

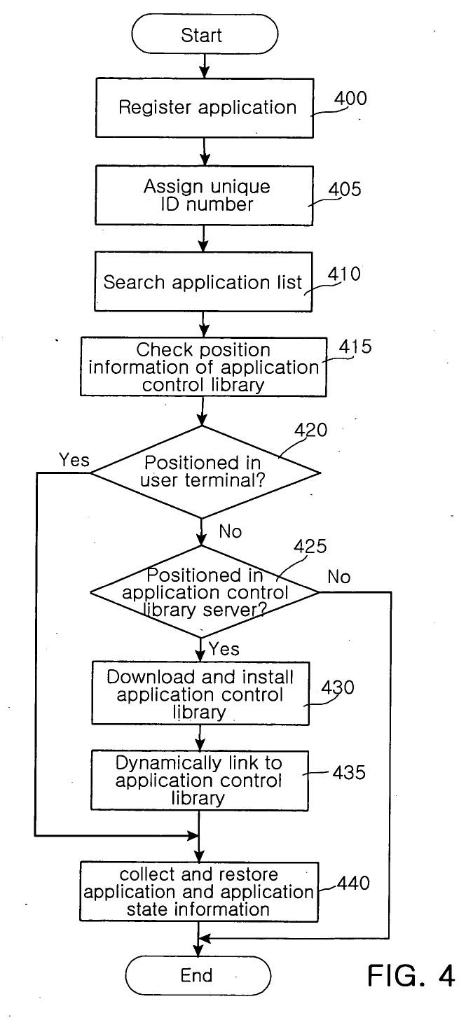

FIG. 4 is a flow chart of a method for collecting and restoring application state information according to an embodiment of the present invention.

As shown in FIG. 4, the application registration management processor 120 receives application information from the applications 110, the application installation program 130, or the application connector 140 at the request of the user. Then, at step 400, the application registration management processor 120 analyzes the received application information and registers a corresponding application through the registration manager 121. Here, if the application information is received from the application 110, the registration manager 121 registers the application when the application is executed, if the application information is received from the application installation program 130, the registration manager 121 registers the application when the application is installed, and if the application information is received from the application connector 140, the registration manager 121 registers an already installed application as an application corresponding to the received application information.

Then, at step 405, to identify registered applications, the registration manager 121 assigns a unique identification number to each of the registered applications.

Then, the application state management processor 120 searches for an application control library of a backup target application that the user has selected from the registered applications. Specifically, at step 410, the application state management processor 120 searches a list of backup target applications for the selected backup target application through the application registration manager 121. Here, the application state manager 122 requests that the application registration manager 121 provide position information of the application control library of the selected backup target application.

Then, the application state management processor 120 determines, through the application state manager 122, whether the application control library is positioned in the user terminal 100 or in the application control library server 200. Specifically, at step 405, the application state management processor 120 checks the position information of the application control library that has been stored after being received within the backup target application. Then, at step 420, the application state management processor 120 determines, based on the checked position information, whether or not the application control library is positioned in the user terminal 100. If the application control library is not positioned in the user terminal 100, the management processor 120 proceeds to step 425, otherwise it proceeds to step 435.

At step 425, the application state management processor 120 determines, through the registration library 121, whether or not the application control library is present in the application control library server 200. If the application control library is not positioned in the application control library server 200, the management processor 120 terminates the procedure, otherwise it proceeds to step 430. At step 430, the application state management processor 120 downloads and installs the application control library through the registration manager 121. Here, the application registration manager 121 responds to the request for the position information of the application control library from the application state manger 122.

Then, at step 435, the application state management processor 120 dynamically links to the application control library found through the application state manager 122. Then, at step 440, the application state management processor 120 selectively collects and restores the application and the application state information using the dynamically linked application control library.

As described above, according to the present invention, it is possible to selectively collect or restore application state information by automatically registering and dynamically linking to an application control library at the request of a user and also to selectively collect or restore various types of application state information without depending on an interface provided by each application.

In addition, a user of a terminal can store only state information of an application which the user desires to back up from among applications running on the terminal and can thereafter restore the same application state information as the backed up state information on another terminal that is located in another place.

Further, in the method according to the embodiments of the present invention, after storing the backed up information in an external server, the user can restore the same work environment as the previously set environment on another terminal located in another place to which the user moves, thereby eliminating the effort and time required to change and set the application environment of the terminal to the same application environment as that previously set on the previous terminal before the user moves.

As is apparent from the above description, the present invention provides a method and apparatus for collecting and restoring application state information which can automatically register and link to an application control library at the request of a user, thereby selectively collecting or restoring application state information, so that it is possible to dynamically add and modify an application control interface provided to selectively collect or restore application state information and also to improve the security of personal data.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for collecting and restoring application state, the method comprising:
receiving information of an application and registering the application;
searching for an application control library of an application which a user has selected from registered applications;
dynamically linking to a found application control library; and
selectively collecting and restoring state information of the application using the dynamically linked application control library.

2. The method according to claim 1, further comprising:
assigning a unique identifier to the registered application; and
canceling registration of the application upon completion of the collection and restoration of the state information of the application.

3. The method according to claim 1, wherein receiving information of the application and registering the application includes receiving information of the application directly from the application and registering the application when the application is executed.

4. The method according to claim 1, wherein receiving information of the application and registering the application includes receiving information of the application from an application installation program and registering the application when the application is installed.

5. The method according to claim 1, wherein receiving information of the application and registering the application includes receiving information of the application from an application connector and registering a previously installed application as the application.

6. The method according to claim 1, wherein searching for the application control library of the application includes:
searching for the selected application from a list of backup target applications;
determining a position at which an application control library for controlling the found application is present, according to a request to locate the application control library;
receiving the application control library from the determined position; and
responding to the request to locate the application control library.

7. The method according to claim 6, further comprising receiving the application control library previously stored in a user terminal if the determined position is the user terminal.

8. The method according to claim 6, further comprising downloading the application control library from an application control library server that manages a plurality of application control libraries if the determined position is the application control library server.

9. A system for collecting and restoring application state, the system comprising an application state management processor including:
an application registration manager that receives information of an application and registers the application and searches for an application control library of an application which a user has selected from registered applications; and
an application state manager that dynamically links to a found application control library and selectively collects and restores state information of the application using the dynamically linked application control library.

10. The system according to claim 9, further comprising an application control library server that manages a plurality of application control libraries and provides the application control library for controlling the registered application to the application state management processor.

11. The system according to claim 9, wherein the application registration manager receives information of the application directly from the application and registers the application when the application is executed.

12. The system according to claim 9, wherein the application registration manager receives information of the application from an application installation program and registers the application when the application is installed.

13. The system according to claim 9, wherein the application state management processor further includes an application connector that provides information used to register a previously installed application as the application.

14. The system according to claim 9, wherein the application registration manager determines a position at which an application control library of an application, which the user has selected from a list of backup target applications, is present and receives and installs the application control library from the determined position of the application control library.

15. The system according to claim 14, wherein the application registration manager receives the application control library previously stored in a user terminal if the determined position is the user terminal.

16. The system according to claim 14, wherein the application registration manager downloads the application control library from the application control library server if the determined position is the application control library server.

17. The system according to claim 9, wherein the application registration manager assigns a unique identifier to the registered application and cancels registration of the application upon completion of the collection and restoration of the state information of the application.
